(19) United States
(12) Patent Application Publication
(10) Pub. No.: US 2008/0027743 A1
(43) Pub. Date: Jan. 31, 2008

(54) Problem Solving Kit

(76) Inventor: John Barend Gerrie, Terrey Hills (AU)

Correspondence Address: MICHAEL MOLINS;MOLINS & CO., SUITE 5, LEVEL 6, 139 MACQUARIE ST, SYDNEY NSW, 2000, omitted

(21) Appl. No.: 11/828,347

(22) Filed: Jul. 26, 2007

(30) Foreign Application Priority Data
Jul. 27, 2006 (AU) 2006904071

(51) Int. Cl. G06Q 99/00

(52) U.S. Cl. 705/1

(57) ABSTRACT

This invention provides a structured process, for business needs such as problem-solving or idea-generation, where records for all thoughts and analyses, obtained by completing a series of main and mini templates with pre-printed questions derived from business theories and techniques, are stored inside a physical shape representing the idea that they are behind. A box containing templates can be turned into a prioritization matrix where all ideas are positioned according to pre-printed or user-defined criteria, which can be described on labels used to identify the matrix axes. The result is a tangible, self-contained, transportable problem-solving cube.

### FIELD OF THE INVENTION

The present invention relates to problem-solving tools, and more particularly, to a kit for resolving various business issues.

### BACKGROUND OF THE INVENTION

In businesses, techniques and methodologies exist to help teams or individuals problem-solve or generate new ideas. Hundreds of these techniques have been developed over time. Examples include SWOT Analysis, Force Field Analysis (KLewin), Brainstorming (A Osborne), Six Thinking Hats (E de Bono), Fishbone Diagrams (K Ishikawa), SCAMPER (B Eberle), Porter's 5 Forces (M Porter), Mind Mapping, Decision Tree, Value Engineering etc. Each technique deals with a specific part or approach to strategy development, problem-solving, decision-making, or idea generation etc.

In recent times, organizations like Eureka Ranch, What If, Synectics, and others, have developed innovation processes combining different techniques and methodologies, some generic and some unique to these companies. Their client organizations are trained to be self-sufficient in using these innovation processes with training workshops and user manuals. These processes are often complex and rely heavily on individuals to keep the process alive and pass on the skill and practice to others. Often the process falls into disuse due to staff turn-over and reorganisations.

The reason many of these processes fail to embed in an organisation is because they largely rely on intellectual adoption and do not have a physical manifestation or presence to support the ongoing use and adoption as people move within the organisation or new people enter the organisation.

### OBJECTS AND SUMMARY OF THE INVENTION

It is the object of the present invention to provide a structured problem-solving or idea-generation process contained within a physical kit of templates, task selection dice and prioritisation tools. The kit leads user(s) through a systematic process with templates providing a step-by-step structure, while allowing the user's output, thoughts and analysis to be captured. The template then folds up into a tangible object containing all the relevant information for the exercise, and can be physically organised according to its fit against factors such as corporate strategies or objectives.

Main folding templates lead users (individuals or teams) through a sequence of questions, with space to capture the answers. Similarly, smaller folding templates are used to lead users through additional tasks or analyses required to generate the answers to the questions on the main templates. The templates are designed such that the summaries or conclusions captured at the end of one stage are always carried over to the next stage, and a task-selection tool is used to direct users to the appropriate smaller or mini folding templates.

The use of templates, folded after their completion, provides a physical shape and space for the ideas or solutions, which can be placed into a prioritization matrix to be evaluated against user-defined criteria such as ease of implementation and business potential. Ideas or solutions, created by one or more individuals or teams, can then be compared to each other.

Accordingly, there is provided a problem solving kit, the kit comprising a frame, one or more matrix strips that are adapted to be supported by the frame. The matrix strips and the frame define a prioritisation matrix that further defines a number of grid cells. The kit also comprises one or more main templates, each main template being foldable into a folded main template. At least one of the grid cells is adapted to support one or more folded main templates.

### BRIEF DESCRIPTION OF THE DRAWING FIGURES

In order that the invention be better understood, reference is now made to the following drawing figures in which:

FIG. 1 is a perspective view of a problem-solving kit;

FIG. 2 is a perspective view of the prioritization matrix;

FIG. 3 is a perspective view of the main template-initial side;

FIG. 4(a) is a perspective view of the main template-action side;

FIG. 4(b) is a plan view of the main template-action side;

FIG. 5(a) is a plan view of the mini template-initial side;

FIG. 5(b) is a plan view of the mini template-action side;

FIG. 6 is a perspective view of a main cube containing smaller cubes; and

FIG. 7 is a perspective view of the prioritization matrix in use.

### BEST MODE AND OTHER EMBODIMENTS

In a preferred embodiment, the present device is a system, or a kit, which contains not only templates for generic problem-solving processes, but also assembly and storage mechanisms that preserve and visually display the evolution of the thought process behind every idea or solution.

A preferred embodiment, as described below, pertains to problem-solving processes, where given a problem (or problems), a solution or action can be reached in a single stage. The innovative problem-solving cubes referred to in this embodiment are cubes, but may take other shapes or configurations such as tetrahedrons, depending on factors such as user preference and task complexity or problem-complexity.

The following paragraphs describe the physical attributes of the device.

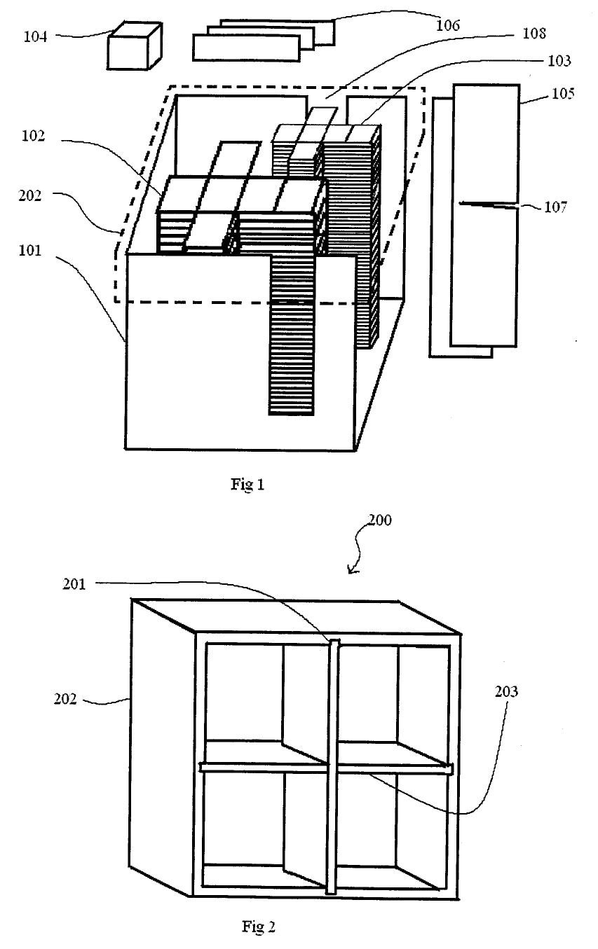

Referring to FIG. 1, the present device includes a preferably transparent plastic box 101 closed by a lid 202, into which the following objects are placed: unfolded main cubes (main templates) 102, unfolded smaller or “mini” cubes (mini templates) 103, a task dice 104, two cardboard matrix strips 105 with partial width-wide slits 107 in the middle, and prioritization labels 106. In this embodiment, the box 101 only has three sidewalls; the open side allows user access to the content of the box. There may also be gaps 108 on one or more sidewalls to facilitate accessing the contents. The prioritization labels 106 may be blank, or may have pre-printed phrases for factors that are commonly used in business prioritization. For embodiments designed for use by more people, or by larger work-groups, more task dice 104 may be included.

Each side of a folded main template 102, has printed on it, a sequence of probing questions related to the business, its marketplace, products, customers etc. The probing questions are developed from a number of theories and techniques. Each main template 102 may also contain a designated space where marks such as “_-_-_” are printed for the users to record perhaps project IDs or dates. Similarly, each side of a folded mini template has printed on it, questions that pertain to the particular task or operation for which the mini template 103 is used. Each side of the folded main or mini templates is therefore large enough to allow space for legible printing and writing of general business questions and answers, and possibly of project IDs and dates.

The mini templates 103 are preferably coloured, such that a different colour is used for the mini templates 103 meant for a different task or operation. It is possible that instead of colours, other differentiators such as motives are used. The task dice 104 is used as a visual legend for the correlation between each colour and each task or operation. For example, the words “diverge” and “converge” may be respectively printed on the blue and red parts of the task dice 104, to indicate that the mini templates 103 used for the tasks “diverge” and “converge” are coloured blue and red, respectively. The task dice 104 therefore has as many different colours as the number of tasks and operations. It is possible that anther tool serving the same purpose, such as an index card or a colour-wheel, is used instead of the task dice 104.

The main templates 102 are made, for example, from heavy-weight cardboard, whereas the mini templates 103 may be made of lighter weight material. Other combinations of materials may be used, as long as the template materials are foldable, and the box, lid and matrix strip materials provide the required rigidity and sturdiness.

Both main and mini templates 102, 103 have printed headings and open writing space to complete each step (of the thinking process). Since this embodiment of the present device applies to single-stage processes, only one type of main template 102 is included. On the other hand, the mini templates 103 are used for a variety of tasks or operations, which may have different complexities and include different numbers of steps. Thus, mini templates 103 used for different tasks or operations may have different shapes, so that when folded they have different numbers of sides, where one side is used for each step. Consequently it is possible that all mini templates 103 do not have the same shape and configuration.

Referring to FIG. 2, there is a width-wise groove 201 in the middle of each inner sidewall of the lid 202. The lid 202 may thus be used as a frame into which the matrix strips 105 can be placed. The matrix strips 105 are of appropriate sizes, so that when they are fitted together as shown in FIG. 2, they form a cross 203 which can be securely placed into the grooves 201. The lid 202 thus becomes a prioritization matrix 200. In other embodiments, there may be more matrix strips which can be assembled together and placed into corresponding grooves to define a different prioritization matrix. The prioritization matrix is a grid that further has a number of grid cells.

The following paragraphs describe how the abstract thought processes leading to each idea are delineated, by the present device, into one retrievable physical object.

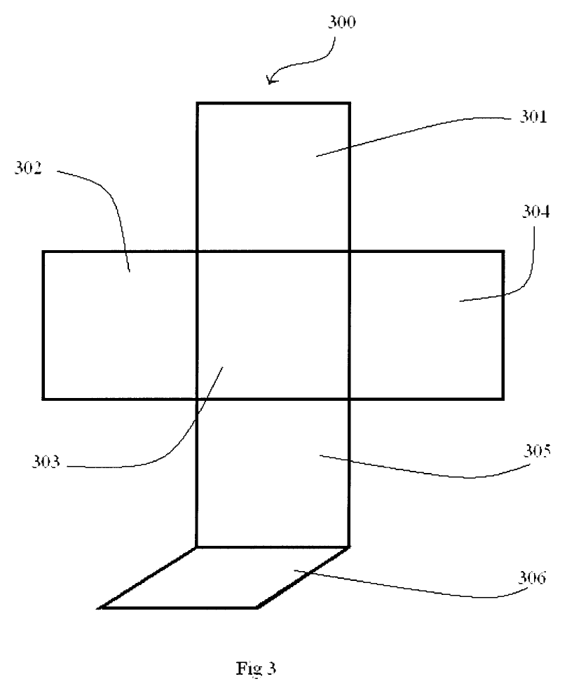

Referring to FIG. 3, each main template 102 has two sides: an initial-side 300, shown here, and an action side 400 on the reverse. These two sides may be printed in different colours. The initial-side 300 has six squares, with a starting square 301, four subsequent question squares 302, 303, 304, 305, and a conclusion square 306. The conclusion square 306 is restricted to being one of the squares having only one neighbour.

In this example, the starting square 301 asks the most general question, such as “What is the problem” and “Why is it a problem”. The subsequent question squares 302, 303, 304, 305, then pose more specific questions. There may be arrows (not shown) to direct the work-flow between these squares, to help the user think about the issue-at-hand in a logical and organized fashion. The conclusion square 306 contains space for the user to write down conclusions about the issue. Since the conclusion square 306 only neighbours one other square, it can be folded over so as to be visible when the user flips to the action-side 400.

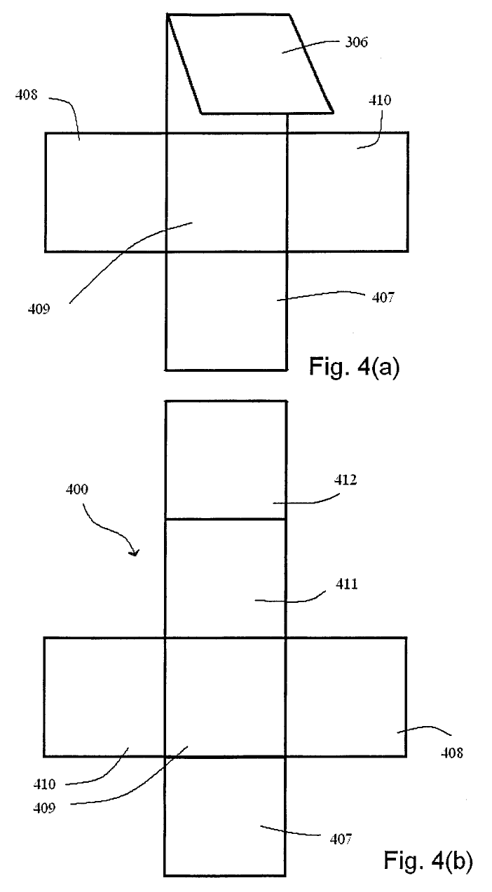

Referring to FIG. 4 (a), the conclusion square 306 from the initial side 300 is folded over and visible from the action-side 400, so that four idea-generation squares 407, 408, 409, 410, are visible, while the next-action square 411, and the new-idea square 412 are concealed. Again, there may be arrows to direct the work-flow between these squares. Since the conclusion square 306 is visible, any intermediate conclusions reached are carried forward, and are visible to the users during the action or idea-generating process.

Referring to FIG. 4 (b), after going through the idea-generation squares 407, 408, 409, 410 the user may unfold the conclusion square 306, to write down details such as “What, who, when, and how” in the next-action square 411, and summarize the final idea in the new idea square 412. The users thus complete the main template 102. The new idea square 412 is an external face of the folded main template.

During the completion of the main template 102, the user may be prompted to use the task selection dice 104. Using this dice, the user selects one of the mini templates 103 as an aid to complete the steps involved in answering the questions printed on the main template 102. The selection of the mini template 103 may be random. For example, the user may throwing the dice 104, and the mini template 103 chosen corresponds to the task that lands “face-up”.

There may also be suggestions, printed on the main templates 102, to recommend relevant mini templates 103 that the users may use. For example, the word “add” may be printed beside the question “What is their/its problem?” on the main template 102. The user then refers to the task dice 104 to see what colour the mini template 103 specific for the “add” task is. There may also be suggestions, printed on the main templates 102, as a hint to the user that he or she may want to consider using a mini template 103.

The user completes the selected or suggested mini template, and writes on the main template 102 the idea reached after completing this mini template 103, in the space provided for the answer to the question. The user can again use the dice to select another mini template, and add that idea to the main template until he or she has a number of viable ideas. These ideas, generated by completing different mini templates, can then be improved upon and turned into one final idea

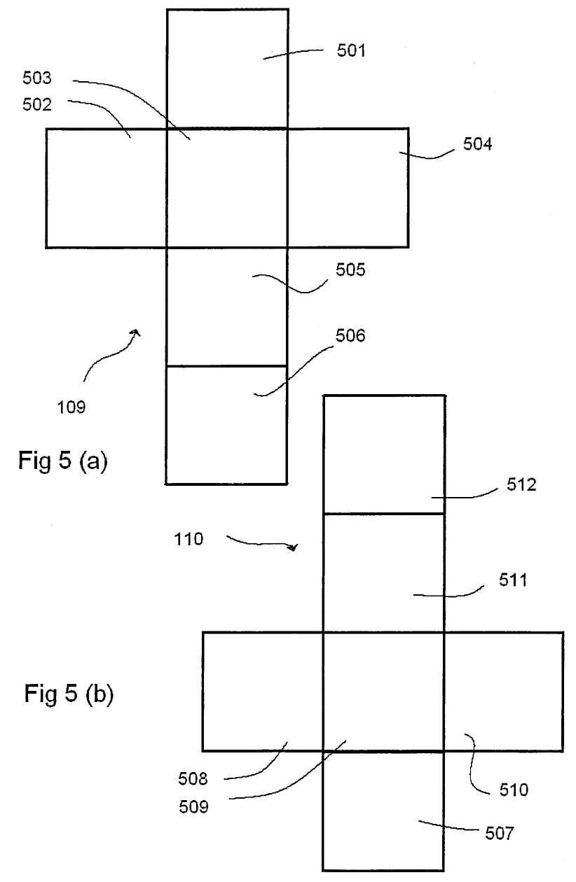

The mini template 103 is completed in a similar fashion as the main template. As shown in FIG. 5 (a), one of the squares on the first side 109 of the mini template 103 is a “task square” 501. The task square describes the particular task that the mini template is relevant for. The other squares 502-506 each relate to a different factor or feature that is considered during the completion of the task. On the second side 110, the five subsequent squares 507-511 reach relate to a further factor or feature that is considered during the completion of the task. The final square, or the “task idea square” 512, is the space where a user writes the conclusions he or she draws by working through the intermediate squares 502-511. The “task idea square” 512 may also be referred to as the “task understanding square”.

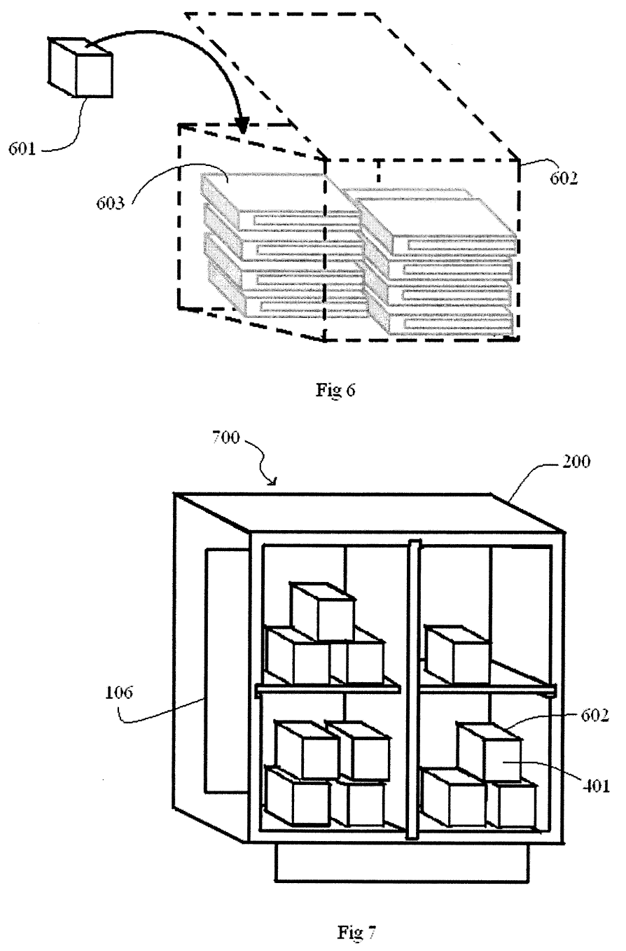

As shown in FIG. 6, used mini templates 103 may be folded into mini cubes 601. The task idea square 512 is an external face of the mini cube 601 and is thus visible when a user views the mini cube 601. Each mini template used whilst answering a main template question is folded into a mini cube 601 and placed into a stack. This placement allows the user to view all of the ideas generated using the mini templates, and decide how the main template question can be answered based on these ideas. After this decision is made, the user can preserve his or her thinking by flattening the mini cubes 601 into flattened mini cubes. The flattened mini cubes 603 are then placed into the folded main template (main cube) 602, shown in dotted lines.

The following paragraphs explain how the present device helps organize, select and execute, and preserve the ideas that have been objectified as described in the preceding paragraphs.

As shown in FIG. 7, the prioritization matrix 200 is populated with all the main cubes 602, which may have been created by one or more individuals or teams, with the new-idea squares 412 facing outwards and visible, according a user-defined structure. For example, this structure can be a 2×2 matrix with “ease of implementation” and “business potential” as the two axes. It is conceivable that the prioritization matrix may contain markings so that a coordinate system can be used to tabulate the matrix locations of the main cubes 602.

The axes are identified by the prioritization labels 106, which may be inserted in see-through clip-on label jackets, or in special slits similar to those used in name-card stands. Thus, each idea written on the main cube 602 is visible, and its ease of implementation and its business potential, compared to other ideas, are represented by its matrix location. The prioritization labels 106 may be interchangeable on the prioritization matrix 200.

After prioritization, it is possible for the completed prioritization matrix with main cubes 700 to be transported to other person(s) or location(s). All the thought processes involved in obtaining the ideas or solutions will have been recorded into the cubes, and the prioritization of ideas will be self-evident.

There may be different versions of problem solving kits. One version is used in a single stage problem solving process. It is directed towards guiding an individual or a small group to solve a relatively simple problem. Preferably the first kit version (“single stage version” or “individual version”) has one type of main template and twelve types of mini-templates. An individual who uses the single stage kit answers all of the questions printed on the main template in the fashion described previously. He or she may use one or more of the mini templates as an aid to answer the main template questions. The task selection dice is used to randomly allocate the mini template to be used. The individual may use a number of main templates to arrive at a number of different ideas. He or she then prioritizes these ideas according to the prioritization matrix.

### Example of a Single Stage Kit

The following questions are printed on the squares of the main templates in a single stage kit. With reference to FIG. 3, the starting square 301 on the initial side 300 asks “What is our problem and why”? The four subsequent squares 302, 303, 304, 305, in sequence, ask “what are the issues”, “where do we want to be and why”, “what have we got”, and “what is our real problem and who/what is causing our problem”. The conclusion square 306 asks “What is their/its problem, that if solved will solve our problem, and why?”

On the action side (see FIGS. 4(a) and (b)), the idea generating squares 407, 408, 409, 410, in sequence, ask the questions “What are the key issues to be solved? Why is this problem being caused”, “How can that problem be solved?”, “How can the solution be improved? Why is this the best solution?”, and “How can it be competitively positioned?” The next action square 411 has printed on it the words “next actions”, and also asks details regarding the next actions, including “what, who, when, how”. The new idea square 412 has printed on it the word “idea”, because this square is where the conclusion of the entire problem solving process is written.

The single stage kit has twelve mini templates that relate to the following tasks: add, subtract, change, contradictions, parallel worlds, invert, converge, diverge, magic wand, increase, decrease, and borrow. These mini templates will be explained in more detail later.

### Multi-Stage Kit

Another version is used in multiple stages. A multi stage version (also “multi stage version” or “team version”) kit has several “sub-kits”. Each “sub-kit” is similar to a single stage version kit, except that the printed text on a single stage version kit is different. A multi-stage version kit is directed toward guiding a team of people to solve a more complicated problem. At each stage of the problem solving process, each subgroup member preferably focuses on different mini templates. Thus different subgroup members think about the same problem from different angles. This method of problem solving helps guide the users to come up with more thorough and multi-faceted solutions.

### Example of a Three Stage Kit

For example, the multi-stage version kit can be designed for a three-stage problem solving process (i.e. a “three stage version”). The three stage version kit has three types of main templates, and a total of six dice and forty-two types of mini templates. The main templates, mini templates, matrix strips, prioritisation labels, and task dice used for each stage of the three stage version are placed into one box. The three boxes may be staked together. The top box is then closed by a single lid. The single lid can be constructed into a prioritisation matrix. Different labels are used at different stages to define the prioritisation matrix.

Preferably the three stage kit is used by a team of (say) twelve or more people. The three stage kit has three types of main templates. These are stage one main templates, stage two main templates, and stage three main templates. A stage one main template guides a user to find the target problem from an existing business problem. A stage two main template guides a user to find an idea that solves the target problem. A stage three main template guides a user to build an innovative concept from the idea generated at the completion of stage two.

A leader of the team presents the business problem to the rest of the team. The team is divided into sub-groups of six people. Each person in the sub-group takes a stage one main template and completes the starting square 301 that asks what the problem is. Each person in the six-person sub-group then completes a different mini template from the following mini templates: “information”, “strategic intent”, “market model”, “SWOT analysis”, “technology”, and “value creation”. The six people in the sub-group may share with the rest of the sub-group his or her new understandings about the problem, after working through the questions posed in his or her mini template.

Each person in the sub-group then continues to work through the initial side (or “part one”) of the stage one main template, and writes an intermediate conclusion in the conclusion square 306. The sub-group then discuss or debate the various intermediate conclusions that the sub-group members have reached. One final conclusion is agreed upon by the subgroup, and will be used by all subgroup members when working through the action side (or “part two”) of the stage one main template.

For the action side of the stage one main template, each person in the subgroup again focuses on one of six different mini templates. The task selection dice may be used to randomly allocate a mini template to each person. These may be “immersion”, “irritation”, “who's who”, “Mars”, “root cause”, and “beliefs, attitude and behaviours”. Again, the sub-group members share their understandings reached by working through the mini templates. The six sub-group members then continue to finish the rest of the action side of the stage one main template and write their “new ideas” in the “new idea” squares 412. The “new ideas” are the “target problems”.

Members of the subgroup then discuss the “target problems”, and agree upon the target problems that will be presented to the entire team They then fold up the main templates into stage one main cubes.

All the main cubes from all the sub-groups are placed together in the prioritisation matrix constructed using the lid and the matrix strips for stage one. The stage one cubes are placed into the prioritisation matrix and is presented to everyone in the team. The team then discusses the “target problems” presented in the stage one prioritisation matrix. They may prioritize the problems based on how big each problem is and how much commitment is required to solve it.

To commence stage two (the “target problem to idea” stage), each sub-group selects one target problem that is presented by a stage one main cube. Different people may choose to work on the same target problem. Each person starts from the initial side of a stage two main template by filling out the initial square 301. The initial square has printed on it the question “What is the problem?” The subsequent squares in the initial side have printed on them, in sequence, the following questions: “what is it part of”, “what is blocking a solution”, “what is it made up of”, “what will enable a solution”. Finally, in the conclusion square 306, there is the printed text “what are key issues to be solved”.

To answer these questions, each subgroup member is assigned one of the mini templates that focus on the following issues: “big picture”, “parts”, “drivers”, “blockers”, “evolution”, and “current solution”. The assignment of the mini templates may be conducted using the task selection dice. For example, the sub-group leader throws the dice in the air. The “task” that lands face-up is assigned to a sub-group member. That member then completes a mini template specific for this task. After completing the mini template, the conclusions are presented back to the sub-group, and the “key issues to be solved” are agreed.

After a user considers the questions printed on the initial side, the user flips the stage two main template over and works on the action side (or “part two”) of the stage two main template. Again using the task selection dice, each member of the sub-group is allocated one of the ideas generation mini-templates: “add”, “subtract”, “converge”, “diverge”, “contradictions”, “parallel worlds”, “increase”, “decrease”, “change”, “invert”, “magic wand”, and “borrow”. These are the same mini templates as those that are used in the single stage version.

The users complete the mini-template, and are allocated another mini-template using the task selection dice. This step may be repeated until each user has, say, at least four ideas. The users present back their ideas to the sub-group, and each user in the sub-group completes the second part of their main template. The user writes down various ideas in the “idea generation” squares 407-410. These ideas may be ones that the user generated, himself or herself, or ones that have been generated by another person. The user then writes down what he or she considers the best idea, which can be a single idea or a composite of several ideas, in the “next action” square 411. The next action square 411 for the stage two main template hence has the text “Best of the best”. Finally, each user writes down his or her concluding new idea in the new idea square 412.

After everyone finishes working through a stage two main template, the subgroup may select which of the new ideas will be presented to the entire team. The stage two main templates bearing these selected new ideas will then be folded into stage two main cubes. The stage two main cubes from all sub-groups will then be placed into a stage two prioritisation matrix. The placement of each stage two main cube in the matrix is based on team discussion. For example, the prioritisation can be made by considering factors such as ease of implementation, and how well the idea fits within a business.

The team then commences stage three to build an innovative concept from the “new idea” concluding stage two. Each subgroup selects one of the stage two main cubes. The sub-group members then write down the new idea presented by the selected stage two main cube in the starting square 301 of a stage three main template. Each sub-group member works through the subsequent squares 302-305 on the initial side (i.e. “part one”). These squares, in sequence, have printed in them the following questions: “What is bad about this idea? What is good about this idea?”, “How to improve the idea?”, “How can we own the idea?”, and “What does it look like?”. Finally, the subgroup member writes his or her “improved idea” in the conclusion square 306 of part one of the stage three main template. The task selection dice is again used to assign each subgroup member a mini template: “what's in it for me?”, “compete with it”, “own it”, “trash it, praise it”, “picture it”, and “improve it”. In some embodiments, each subgroup member may choose the mini template that he or she will complete. All subgroup members then compare and discuss their “improved ideas”. Each member can use his or her own improved idea, that of another, or a combination of different improved ideas, to start part two of the stage three main template. In the idea generation squares 407-410 of the stage three main template, a subgroup member answers the following questions in sequence: “Who are we really appealing to? why does this really solve their problem?”, “What is the compelling benefit? How is it really going to change anything”, “What is the dramatic difference? How is it really going to change anything?”, and “What is the real reason to believe? How is it really going to change anything?” In the next action square 411 of the stage three main template, the user lays out an action plan. The stage three next action square 411 may thus be a table with “what”, “who”, and “when” as column headings. Finally, the subgroup member writes down his or her improved idea in the stage three new idea square 412. The stage three new idea square 412 may have the printed text “innovative idea”, to indicate that it is the space in which concluding innovative ideas should be written. In completing part two of the stage three main template, each subgroup member is allocated a mini template using the task selection dice, focuses on one of the following issues or tasks: “targeting”, “sticking”, “wowing”, “aligning”, “competing”, and “actioning”.

After each subgroup member comes up with his or her innovative idea, the subgroup members discuss and compare all the innovative ideas and select those innovative ideas that will be presented to the team. The stage three templates bearing the selected innovative ideas are folded into stage three main cubes.

The team discusses and compares the innovative ideas presented by the stage three main cubes, and place the stage three main cubes into the stage three prioritisation matrix. The axes of the stage three prioritisation matrix can be, for example, uniqueness of each innovative idea and relevance of each innovative idea. The three stage kit has now enabled the team to directly view an array of innovative ideas, the uniqueness of the ideas, as well as the relevance of the ideas compared to the original problem.

### Examples of Mini Templates

The task square 501 of any mini template mentioned above has a text or picture printed on it, to show which task or focus that particular mini template is used for. The intermediate squares 502-511 of each mini template contain questions or hints of issues that the user considers. The intermediate squares for different mini templates ask different questions. The “new perspective” square 512 presents each user with a space to write down the new perspective, understanding, or improvement that he or she arrives at after considering the questions is printed in the intermediate squares.

The “add” mini template has the following printed words in the squares. In the task square 501, the word “Add”, as well as a statement that explains the “Add” task, are printed. For example, the explanation for the “Add” task is: “Add something useful to the current system that could solve the problem. It could be something directly related to the current system, product or service—a new benefit or ingredient, or it could be something useful from a parallel, alternative or even unrelated field—an ingredient not previously associated or even an emotion. Work through the task and complete each box with one or more useful things that could be added.” The intermediate squares 502-511 each relate to one the following factors to be considered: function, usage, feature, benefit, emotion, ingredient/component, availability/exposure and value/cost, performance and uniqueness, customer and users, and finally, shape or form. In some intermediate squares, the words “For a related, associated, complementary or supplementary field? From parallel, alternative or unrelated field?” are also printed, so as to add more dimensions in the consideration for the factor.

For the “subtract” mini template, the task square 501 has printed in it the word “Subtract” and also a statement explaining the “Subtract” task. Similarly, the task squares for all other mini templates name the specific tasks and contain explanatory statements for the tasks. The same factors considered in the intermediate squares of the “add” mini template are also considered in the intermediate squares of all other mini templates used in the single stage version, with the exception of the “Borrow” mini template.

For the “Borrow” mini template, the user is directed by the intermediate squares 502-511 to consider different factors in the following sequence: “function/usage and feature”, “benefit and emotion”, “ingredient/components and shape/form”, “performance/uniqueness and value/cost”, “customer/user and availability/exposure”, “from nature”, “from the movies”, “from famous people”, “from another country”, and “from fantasy”.

For the “information” mini template, the subsequent squares 502-511, in sequence, ask the following questions: “What is happening? Why?”, “What is the problem?”, and “What else is happening (related, associated, or supplementary field)? Why?” Some of these questions may be printed in more than one square.

For the “strategic intent” mini template, the subsequent squares 502-511, in sequence, ask the following questions: “How do we see ourselves in the future?”, “why do we want to be there”, “How do we plan to get there?”, “Where are we now?”, “Why are we there? How did we get there?”, “What needs to change?” “What needs to be done?”, “What needs to stay?”, “When does it need to be done?”, and “Who needs to do it?”.

For the “market model” mini template, the subsequent squares 502-511, in sequence, ask the following questions: “Who is the end-user? Why do they buy it?”, “What are we selling? What does it do?”, “Who are we selling to? Why do they buy it?”, “How are we selling it? Where are we selling it?”, “Who makes it? Where is it made?”, “What drives loyalty/repeat? Why?”, “What drives purchase decisions” Why?”, “Who do we compete with (directly)?”, “What market/industry is similar?”, and “Who do we compete with (indirectly)?”

For the “SWOT analysis” mini template, the subsequent squares 502-511, in sequence, ask the following questions: “What are our opportunities?”, “What are our strengths?”, “What are our threats?”, “What are our weaknesses?”, “What strengths to build on? What weaknesses to correct?”, “What opportunities to exploit? What threats to counter?”, “What is the key opportunity? Why? How (to exploit or optimise)?”, “What is the key weakness? Why? How (to correct or eliminate)?”, “What is the key threat? Why? How (to counter or avoid)?”, and “What is the key strength? Why? How (to maintain, build, or leverage)?”.

For the “technology” mini template, the subsequent squares 502-511, in sequence, ask the following questions: “What delivers the main actions? How does it work?”, “What does it do? Main action? Secondary actions? Additional actions?”, “What delivers other actions” How does it work”?, “What else helps the function? How is it made?”, “What tells you it is working? What else do you see, hear, feel or smell?”, “What has driven innovation? How?”, “What technologies are similar? What is happening here?”, “Where does new technology come from? What drives technology advances?”, “Who controls the technology? Who is investing in innovation?” and “What was the last major technology breakthrough? What effect did it have?”.

For the “value creation” mini template, the subsequent squares 502-511, in sequence, ask the following questions: “What causes customers to want to pay less? Pay more?”, “What determines the price?”, “Where is value added in the supply chain?”, “Who else adds value? Before? After?”, “What adds cost but does not add value? What adds value but does not add cost?”, “What is the impact on value of: brand? company?”, “What is the impact on value of: service? manufacturing?”, “What is the impact on value of: supply, distribution?”, “What is the impact on value of: quality, people?”, and “What is the impact on value of: technology, design?”.

For the “big picture” mini template, the subsequent squares 502-511, in sequence, ask the following questions: “What is it? Function? Benefits?”, “What is it/that part of? Function? Benefit?”, “What things are complementary (used with this product/service)? Function? Benefit?”, “What things are supplementary (used to add functions/benefits/usage to this product/service” Function? Benefits?”, “What else competes for same $s? Function? Benefit?”, “What parallel/alternative field? Function? Benefit?”, “What could replace it? Function? Benefit?”, “What unrelated field? Function? Benefit?”, “What if it never existed?”.

For the “parts” mini template, each of the intermediate squares 502-511 asks “what is it made up of? Function? Benefit?”. The new perspective the user achieves after considering all the different parts is written in the “new perspective square” 512.

For the “drivers” mini template, each of the intermediate squares 502-511, in sequence, ask the following questions: “What drives success? Functions? Usage?”, “What features drive success?”, “What drives success (ingredient/component)? Form/Shape?”, “What benefits drive success?”, “What emotions drive success?”, “What drives uniqueness? How?”, “How does availability drive success? How does exposure drive success”, “What customers drive success? How does technology drive success?”, “What drives value? What a drives loyalty?”, and “What drives performance? How?”.

For the “blockers” mini template, each of the intermediate squares 502-511, in sequence, ask the following questions: “What blocks success? Functions? Usage?”, “What features block success”, “What blocks success (ingredient/component)? Form/shape?”, “What benefits block success?”, “What emotions block success?”, “What blocks uniqueness? How?”, “How does availability block success? How does exposure block success?”, “What customers block success? How does technology block success?”, “What destroys value? What destroys loyalty?”, and “What blocks performance? How?”.

For the “evolution” mini template, each of the intermediate squares 502-511, in sequence, ask the following questions: “What drove the current solution? What problem did it solve?”, “What did it replace? ”, “How does functionality drive change? How does usage drive change?”, “How do benefits drive change? How does emotion drive change?”, “How does value/cost drive change? How does form/ingredients drive change?”, “How does technology drive change? How does performance drive change?”, “What will drive the next change? How can we take advantage?”, “What will block the next change? How can we take advantage?”, and “How does uniqueness drive change? How does availability/exposure drive change?”.

For the “current solutions” mini template, each of the intermediate squares 502-511, in sequence, ask the following questions: “What—Functions (what does it do and how does it do it)?”, “How—Usage (how is it used and for what purpose)?”, “What—Feature (what specific advantages or features does it offer?”, “What—Benefits (what does it do for you or what do you get out of it)?”, “What—Emotions (what does it do for you emotionally, how does it make you feel or what emotional need does it address)?”, “What—Ingredient/component (what is it made up of)? What—Shape or form (what does it look and feel like)?”, “Where—Availability (where will you find it)? How—Exposure (how will you know about it)?”, “Who—Target (who is it targeted at, and who are the users)? Who—Customer (who are the customers)?”, “What—Value/cost (what makes it worth what you pay for? How ?”, and “What—Performance (what makes it do what it does and what tells you it does what it says it does)? Why—Uniqueness (what makes it different from others)?”.

For the “immersion” mini template, the subsequent squares 502 and 503 ask the question “What is happening? Why?” and “Where is the problem area? Who?”. The next two subsequent squares 504, 505 also ask “What is happening? Why?”. The user writes down an intermediate new insight in the next subsequent square 506. The next subsequent square 507 has printed on it a hint or instruction that tells the user how to immerse himself or herself in a hypothetical problem. For example, the following text may be printed: “Pick a related world—similar problems and issues in the problem area. Immerse yourself in this world. See with new eyes what is happening that could provide new insight for your problem area.” The next subsequent square 508 asks the user to describe the related world by answering the “where” and “who” question. The next three subsequent squares 509-511 ask the question “What is happening? Why?”

For the “irritation” mini template, the subsequent squares 502 and 503 ask the question “What ticks you off? Why?” and “Where is the problem area? Who?”. The next two subsequent squares 504, 505 also ask “What ticks you off? Why?” The user writes down an intermediate new insight in the next subsequent square 506. The following subsequent square 507 has printed on it a hint that helps the user deal with the issue of irritation. For example, the following text may be printed: “Look beyond the current problem area, see what else makes them/it react. What else generates a similar level of passion or reaction, prod it—see what happens.” The next subsequent square 508 asks the user to describe the related world by answering the “where” and “who” question. The next three subsequent squares 509-511 ask the question “What ticks you off? Why?”

For the “who's who” mini template, the subsequent squares 502 and 503 ask the question “What/who is the decision-maker? How?” and “What/who is the doer or user? How?”. The next two subsequent squares 504, 505 ask “What/who has direct influence? How?” The user writes down an intermediate new insight in the next subsequent square 506. The following subsequent square 507 has printed on it a hint that helps the user consider the issue of who's who. For example, the following text may be printed: “Look at a related activity, look at how that works, who does what and how” The next subsequent squares 508-511 ask, in relation to the related activity, “What/who is the decision maker? How?”, “What/who has indirect influence? How?”, “What who has direct influence? How?”, and “What/who is the doer or user?How?”

For the “Mars” template, each of the intermediate squares 502-511, in sequence, ask the following questions: “What is it?”, “what does it do? how does it work?”, “What does it look like? What does it smell like? What does it feel like?”, “How is it used? Why is it used?”, “When is it used/Where is it used?”, “Who uses it? What are they like?”, “Where does it come from? How do you get it? Where do you get it”, “When can't it be used? How can't it be used? Where can't it be used?”, “What else could it be used for? What could be used instead? What is it used with?”, and “What happens when it is used? What happens if it is not used?”

For the “root cause” mini template, each of the intermediate squares 502-511, in sequence, ask the following questions: “Why is it happening? What/who is causing it?”, “What is the real problem?”, “Why is that happening? What/who is causing it?”, “why is that happening” What/who is causing it?”, “What/who else could be involved? How is that impacting on the problem?”, “What/who is the root cause?”, “Where is it being caused?”, “Why is that being caused”, “How is it being caused?”, and “When is it being caused?”

For the “beliefs, attitude and behaviours” mini template, each of the intermediate squares 502-511, in sequence, ask the following questions: “What is happening? Why is it happening?”, “Behaviour, action or response—What is happening? Why is it happening?”, “What is happening? Why is it happening?”, “Attitudes, position, or emotions-what?”, “How is that driving behaviour?”, “What are the beliefs or deep-seated views?”, “Why are they held?”, “What is indirectly associated? Why?”, “What is directly associated?Why”, and “How is that driving behaviour?”

For the “what's in it for me” mini template, each of the intermediate squares 502-510, in sequence, ask the following questions: “What is so good about this? Why should I believe you?”, “How does it solve my problems? How does it do it?”, “What does it do for me? Why should I use it?”, “What is in it for me? Why should I care?”, “How is it better than my current solution? Why is it better than my current solution?”, “How can it do more for me? How can you make it easier for me?”, “What will make it better for me? Why?”, “How can it be improved for me?”, and “How can you give me more value for money/How can it make me feel better?” The next square 511 provides a space in which the user may write down his or her wish list, after considering the aforementioned questions. The user then writes down the concluding “new improvement” in the new idea square 512.

For the “own it” mini template, the intermediate squares 502-510, in sequence, ask the following questions: “What have we got that is ownable (unique, distinctive, a barrier against competition or gives protection against foes)?”, “What can no one else do? Why?”, “What can no one else say? Why?”, “What can give us ownability or brand personality?”, “What is the distinctive design? What is the unique shape or form?”, “What are the technology barriers?”, “How to make it more ownable?”, “How can we stop anyone copying us? What is the legal protection?”, and “How can we improve this idea”. The next square 511 provides a space in which the user may write down his or her wish list of things that would make his or her idea more distinctive, unique, and ownable. The user then writes down the concluding “new improvement” in the new idea square 512.

For the “picture it” mini template, the intermediate squares 502-511, in sequence, ask the following questions: “What does it do?”, “How do you use it?”, “How does it work?”, “What does it do for you?”, “How does it make you feel?”, “What does it look like?”, “Where will you find it?”, “What improvements?”, “What else does it need?”, and “What do you wish it had?”. The user then writes down the concluding “new improvement” in the new idea square 512.

For the “compete with it” mini template, the intermediate squares 502-511, in sequence, ask the following questions: “How can they beat our functionality?”, “How can they improve on our usage?”, “What features could they add?”, “How can they provide better benefits?”, “How can they provide better emotional benefits?”, “How can they add something better? How can they add more value?”, “How can they make theirs look better? How can they make theirs work better?”, “How could they make theirs better?”, “What else could they do to compete with it?”, and “What else could they wish for?”. The user then writes down the concluding “new improvement” in the new idea square 512.

For the “trash it, praise it” mini template, the intermediate squares 502-511, in sequence, ask the following questions: “What function—that is trash or great?”, “What usage—that is trash or great?”, “What feature—that is trash or great?”, “What emotion—that is trash or great?”, “What ingredient/component/shape/form—that is trash or great? What performance—that is trash or great?”, “What value/cost—that is trash or great? Why is it unique—that is trash or great?”, “How could it be improved”, “How could it be trashed?, and “What wish could be improved?”

For the “improve it” mini template, the intermediate squares 502-511, in sequence, ask the following questions: “How can it do more? What functionality can we borrow from a parallel world?”, “How can it work better? What usage can we borrow from a parallel world?”, “How can we give it more features? What features can we borrow from a parallel world?”, “How can it provide more benefits? What benefit can we borrow from a parallel world?”, “How can we improve the emotional benefits? What emotions can we borrow from a parallel world?”, “How can the ingredients/components be improved? How can availability or exposure be improved?”, “How can we add more value? How can cost be improved?”, “How can something from a parallel world be used?, “How can we improve it?”, and “What do we wish we could improve?”

For the “targeting” mini template, the intermediate squares 502-507, in sequence, ask the following questions: “Who are we targeting?”, “what is their problem? What is their real problem?”, “What makes them tick? What do they want out of life?”, “What appeals to them? What do they believe?”, “How will we make them change? How do we appeal to them?”, and “Why should they believe us? Why should they listen?” In the next three squares 508-510, the user populates a list of “next actions, how to proceed, when, and who”. The following square 511 asks the question “What do we say to win their hearts? What do we say to win their minds?”. Finally, in the new perspective square 512, the user is asked to write down something that will make the biggest connection with his or her target.

For the “wowing” mini template, the intermediate squares 502-505 ask the question “What can we show or say (functionality, usage)? What evidence do we have or need?” The next square 506 asks “What do we wish we could say or do? How can we create the support?” In the next square 507, the user is asked to write down the “wow claims”, or claims which would impart the wow factor for his or her product or service. In the next three squares 508-510, the user populates a list of “next actions, how to proceed, when, and who”. The next square 511 is the “wow demo” square. The user writes down functionalities, performances, benefits, or the like, of a service or product, to demonstrate the wow factor of this service or product. In the new perspective square 512, the user is asked “What is the single most compelling thing we can do or say?”

For the “competing” mini template, the intermediate squares 502-507, in sequence, ask the following questions: “What/who are we competing with directly or indirectly?”, “What are we up against directly or indirectly?”, “What have we got? Why is that better?”, “How will we compete? Where? When?”, “What is our competitive point of difference ? Why will we beat them?”, and “What benefit will we deliver better? How will we be more distinctive?” In the next three squares 508-510, the user populates a list of “next actions, how to proceed, when, and who”. The next square 511 has printed in it the question “Why will we be more believable? How will we be more persuasive?”. Finally, in the new idea square 512, the user is asked “What is the one thing that will give us an undisputed competitive advantage?”

For the “sticking” mini template, the intermediate squares 502-507, in sequence, ask the following questions: “What do they need to do differently? What compelling action will achieve this?”, “How do they need to think differently? What compelling action will achieve this?”, “What beliefs need to change? What compelling action will achieve this?”, “How will we persuade them? Why will they believe us?”, “Why is it better than what they currently have? What is so unique and distinctive about it?”, “What is the compelling benefit? What is the distinctive difference?” In the next three squares 508-510, the user populates a list of “next actions, how to proceed, when, and who”. The next square 511 has printed in it the question “What is the reason to believe? What is persuasive communication?” Finally, in the new idea square 512, the user is asked “What is the most impactful thing we could say or do to convince someone this is the next biggest thing since sliced bread?”

For the “aligning” mini template, the intermediate squares 502-507, in sequence, ask the following questions: “How does this support strategy? Why?”, “What are the business benefits?”, “How does it fit with current equity? How does it fit with other parts of the business?”, “What are the business risks”, “What resources are required”, and “What/who will block this idea?” In the next three squares 508-510, the user populates a list of “next actions, how to proceed, when, and who”. The next square 511 has printed in it the question “What or who will block this idea?” Finally, in the new idea square 512, the user is asked “What is the one thing that will get guaranteed support for this idea?”

For the “actioning” mini template, the intermediate squares 502-506, in sequence, ask the following questions: “What needs to be done to deliver: uniqueness/compelling benefits? To deliver unique distinctive format?”, “What needs to be done to deliver: uniqueness compelling differences? To deliver convincing reason to believe?”, “What needs to be done to deliver: competitive performance? To deliver unique offer?”, “What needs to be done to deliver: competitive claims? To deliver WOW impact?”, and “What needs to be done to deliver: brand imagery or equity? To deliver protectable property?” In the following square 507, the user populates a list of—What or Who could be the blockers, and what needs to be done to counteract the blockers. In the next three squares 508-510, the user populates a list of “next actions, how to proceed, when, and who”. In the next square 511, the user populates a list of what or who could be enabled, and how can this help. In the last square 512, the user populates a list of who is going to move it forward, and what these people will do.

While the present invention has been disclosed with reference to particular details of construction, these should be understood as having been provided by way of example and not as limitations to the scope or spirit of the invention.

What is claimed is:

1. A problem solving kit, comprising:
a frame;
one or more matrix strips that are adapted to be supported by the frame;
the matrix strips and the frame defining a prioritisation matrix;
the prioritisation matrix further defining a number of grid cells;
one or more main templates, each main template being foldable into a folded main template, wherein
at least one of the grid cells is adapted to support one or more folded main templates.

2. The problem solving kit of claim 1, wherein,
the folded main template is a cube.

3. The problem solving kit of claim 1, wherein,
one side of the main template is an initial side, and an opposite side of the main template is an action side, wherein the initial side and the action side are differently coloured.

4. The problem solving kit of claim 3, wherein,
the action side is exposed when the main template is folded into the folded main template.

5. The problem solving kit of claim 1, wherein,
the folded main template has faces, wherein each face of the folded main template is large enough to allow legible printing of a general business question and answers to the questions.

6. The problem solving kit of claim 1, further comprising,
one or more mini templates, each mini template being foldable into a folded mini template.

7. The problem solving kit of claim 6, wherein,
each folded mini template is a cube.

8. The problem solving kit of claim 6, wherein,
each mini template has two sides, wherein each side is large enough for legible printing of a general question relevant to a task.

9. The problem solving kit of claim 8, wherein,
each folded mini template has external faces, wherein one of the external faces is large enough for legible printing of a solution or a conclusion relating to the task.

10. The problem solving kit of claim 8, wherein,
two of the mini templates are relevant to two different tasks.

11. The problem solving kit of claim 10, further comprising,
a task selector, the task selector offering a visual clue that links the mini templates to the tasks.

12. The problem solving kit of claim 11, wherein,
the task selector and the mini templates are colour coded so that one colour corresponds to one different task, wherein a colour code of the task selector corresponds to a colour code of the mini templates.

13. The problem solving kit of claim 12, wherein,
the task selector is a dice having differently coloured sides.

14. The problem solving kit of claim 1, wherein,
the frame has four inner sidewalls, each inner sidewall having formed in it a width-wise groove, wherein each matrix strip is secured into cooperating grooves formed into opposite inner sidewalls.

15. The problem solving kit of claim 1, wherein,
two of the matrix strips are adapted to intersect one another to form a cross.

16. The problem solving kit of claim 1, wherein,
the frame is a lid for a box that contains the main templates and the matrix strips.

17. The problem solving kit of claim 16, wherein,
the box is at least partially see through.

18. The problem solving kit of claim 16, wherein,
a sidewall of the box has formed in it a gap for facilitating access to a content of the box.
